(19) United States
(12) Patent Application Publication
(10) Pub. No.: US 2007/0076051 A1
(43) Pub. Date: Apr. 5, 2007

(54) Liquid ejection head and manufacturing method thereof

(75) Inventors: Takamichi Fujii, Ashigara-Kami-Gun (JP); Yoshinobu Nakada, Ashigara-Kami-Gun (JP); Yukio Sakashita, Ashigara-Kami-Gun (JP); Yoshikazu Hishinuma, Ashigara-Kami-Gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/528,433

(22) Filed: Sep. 28, 2006

(30) Foreign Application Priority Data
Sep. 30, 2005 (JP) 2005-288819

(51) Int. Cl. B41J 2/155

(52) U.S. Cl. 347/42

(57) ABSTRACT

The liquid ejection head has a liquid ejection device which ejects liquid and is partially formed of a directionally solidified silicon substrate.

### BACKGROUND OF THE INVENTION

1. Field of the Invention

The present invention relates to a liquid ejection head and a manufacturing method thereof, and more particularly, to a liquid ejection head used in an inkjet recording apparatus and a manufacturing method thereof.

2. Description of the Related Art

Japanese Patent Application Publication No. 2001-353866 discloses an inkjet head in which the liquid chamber substrate includes a diaphragm made of a metallic film, and a liquid chamber forming substrate made of glass or ceramic. Glass substrates are inexpensive; however, they cannot be subjected to anisotropic etching, and hence high-precision processing is difficult to achieve. Moreover, glass substrates have low thermal resistance, and hence there are issues of process compatibility of forming piezoelectric films, and the like. On the other hand, in ceramic substrates, distortion and processing non-uniformities are not avoidable when the ceramic is sintered, and it is very difficult to achieve highly accurate processing.

Japanese Patent Application Publication No. 54-150127 discloses an inkjet gun. having nozzles, which spray ink, formed in a monocrystalline silicon wafer by anisotropic etching. However, monocrystalline silicon wafers are expensive. Moreover, the maximum available size of silicon wafers is around 300 mm in diameter at present, and this is problematic in that the size is small when seeking to manufacture a large printer head. Furthermore, the monocrystalline silicon wafers have a bending strength of around 80 MPa, and the higher bending strength is needed to achieve the higher reliability.

### SUMMARY OF THE INVENTION

The present invention has been contrived in view of the foregoing circumstances, an object thereof being to provide a liquid ejection head and a method of manufacturing a liquid ejection head, whereby a liquid ejection head of large surface area having excellent thermal resistance and rigidity can be manufactured by using inexpensive materials, with a high processing accuracy.

In order to attain the aforementioned object, the present invention is directed to a liquid ejection head comprising a liquid ejection device which ejects liquid and is partially formed of a directionally solidified silicon substrate.

According to this aspect of the present invention, the liquid ejection head is manufactured from the directionally solidified silicon substrate, which is inexpensive, has excellent rigidity and is processed with high accuracy. Furthermore, the directionally solidified silicon substrate has excellent thermal resistance. Therefore, since film formation can be performed at high temperature when forming piezoelectric films on the directionally solidified silicon substrate as drive devices, then the performance of the piezoelectric films can be improved.

Preferably, the liquid ejection head device includes: a nozzle plate which has nozzles arranged in an array; pressurization liquid chambers which are bonded to the nozzle plate and respectively connected to the nozzles; a top plate which has fluid resistance channels connecting the pressurization liquid chambers and a common liquid chamber for storing ink, the ink being supplied through the fluid resistance channels to the pressurization liquid chambers; and a drive plate which has drive devices for causing the ink in the pressurization liquid chambers to be ejected from the nozzles, wherein at least a part of the nozzle plate, the pressurization liquid chambers, the top plate and the drive plate is made of the directionally solidified silicon substrate.

Preferably, the directionally solidified silicon substrate forming the liquid ejection device is constituted by a single component having a length not less than a full width of a print medium on which the ejected liquid is deposited.

According to this aspect of the present invention, it is possible to manufacture the liquid ejection head corresponding to the full width of the print medium, without joining together small liquid ejection heads, and therefore it is possible to print accurately onto the print medium by means of a single pass (without moving the head in the breadthways direction of the print medium).

Preferably, the length of the directionally solidified silicon substrate is 150 mm or greater.

Further preferably, the length of the directionally solidified silicon substrate is 200 mm or greater.

Even preferably, the length of the directionally solidified silicon substrate is 300 mm or greater.

Preferably, a bending strength of the liquid ejection device is not less than 83 MPa.

In order to attain the aforementioned object, the present invention is also directed to a method of manufacturing a liquid ejection head, comprising the steps of: forming a substrate which is made of directionally solidified silicon and has a width not less than a full width of a recording medium; forming pressurization liquid chambers and fluid resistance channels in the substrate, the fluid resistance channels connecting the pressurization liquid chambers and a common liquid chamber for storing ink, the ink being supplied through the fluid resistance channels to the pressurization liquid chambers, the ink being pressurized in the pressurization liquid chambers; forming a drive plate which has drive devices for causing the ink in the pressurization liquid chambers to be ejected from nozzles; and cutting out a liquid ejection head by dicing the substrate.

According to the present invention, it is possible to manufacture the liquid ejection head from the directionally solidified silicon substrate, which is inexpensive, has excellent rigidity and thermal resistance and is processed with high accuracy. Since the directionally solidified silicon substrate can be formed to a large surface area, then it is also possible to manufacture the liquid ejection head corresponding to the full width of the print medium, without joining together small liquid ejection heads. Moreover, since a plurality of long liquid ejection heads can be manufactured by means of one manufacturing process, it is possible to reduce the cost of the liquid ejection heads. Furthermore, since there are no variations caused by joints between heads, stable ejection can be achieved over a long period, reliability is high, and there is no occurrence of streak, or the like, then high-quality printing is possible.

### BRIEF DESCRIPTION OF THE DRAWINGS

The nature of this invention, as well as other objects and benefits thereof, is explained in the following with reference to the accompanying drawings, in which like reference characters designate the same or similar parts throughout the figures and wherein:

FIG. 1 is a general schematic drawing showing an inkjet recording apparatus;

FIG. 2 is a plan diagram showing the principal composition of the peripheral area of a print unit of an inkjet recording apparatus;

FIGS. 3A to 3G are diagrams showing a method of manufacturing a liquid ejection head according to a first embodiment of the present invention;

FIGS. 4A to 4C are diagrams showing a method of manufacturing a substrate made of directionally solidified silicon; and

FIGS. 5A to 5F are diagrams showing a method of manufacturing a liquid ejection head according to a second embodiment of the present invention.

### DETAILED DESCRIPTION OF THE PREFERRED EMBODIMENTS

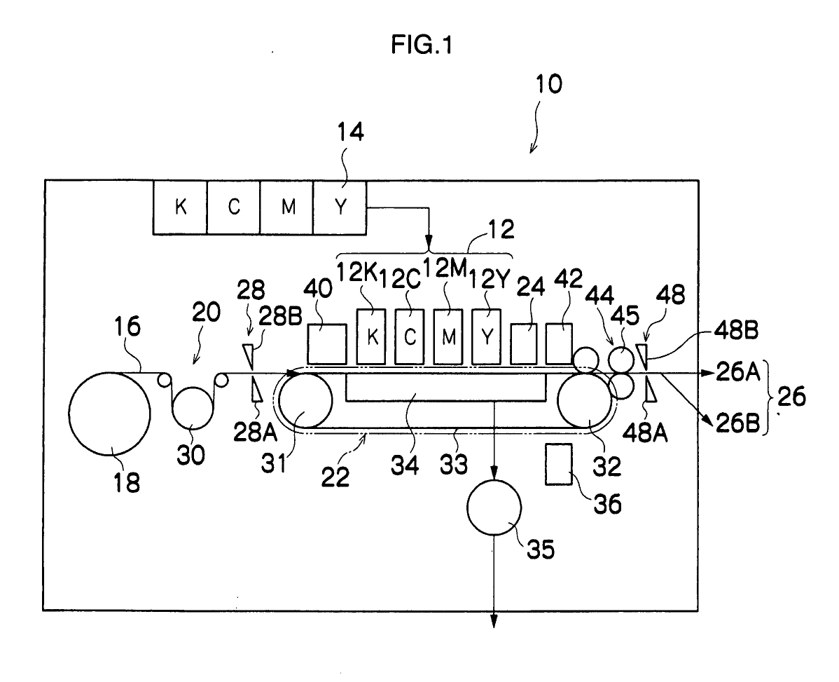

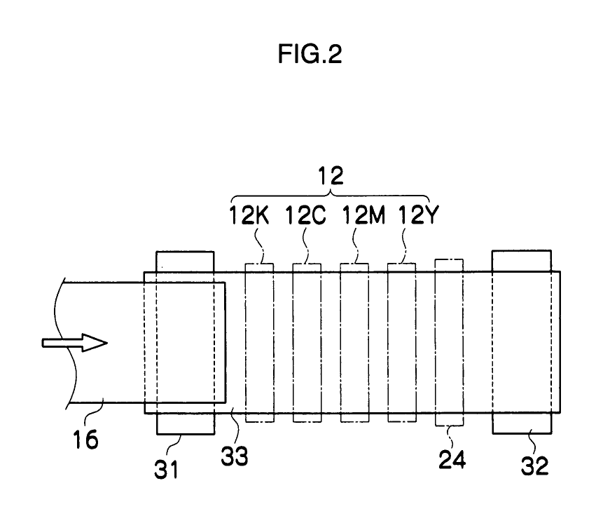

Firstly, an inkjet recording apparatus to which a liquid ejection head according to an embodiment of the present invention is applied is described with reference to FIGS. 1 and 2. FIG. 1 is a general schematic drawing of the inkjet recording apparatus.

As shown in FIG. 1, the inkjet recording apparatus 10 comprises: a print unit 12 having a plurality of liquid ejection heads (hereinafter, simply called “heads”) 12K, 12C, 12M, and 12Y for respective ink colors of black (K), cyan (C), magenta (M) and yellow (Y); an ink storing and loading unit 14 for storing inks of K, C, M and Y to be supplied to the print heads 12K, 12C, 12M, and 12Y; a paper supply unit 18 for supplying recording paper 16; a decurling unit 20 for removing curl in the recording paper 16; a suction belt conveyance unit 22 disposed facing the nozzle face (ink droplet ejection face) of the print unit 12, for conveying the recording paper 16 while keeping the recording paper 16 flat; a print determination unit 24 for reading the printed result produced by the print unit 12; and a paper output unit 26 for outputting printed recording paper (printed matter) to the exterior.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine.

Since roll paper is used as the recording paper 16, the inkjet recording apparatus shown in FIG. 1 is provided with a cutter (first cutter) 28. The roll paper (recording paper 16) is cut to a prescribed size by means of this cutter 28. The cutter 28 according to the present embodiment comprises a stationary blade 28A having a length equal to or exceeding the width of the conveyance path of the recording paper 16, and a circular blade 28B which moves along the stationary blade 28A. The stationary blade 28A is provided on the rear side of the print surface of the recording paper 16, and the circular blade 28B is disposed on the print surface side, across the conveyance path from the stationary blade 28A. If cut paper is used as the recording paper 16, then the cutter 28 is not necessary.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the print unit 12 and the sensor face of the print determination unit 24 forms a horizontal plane (flat plane).

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the print unit 12 on the interior side of the belt 33, which is set around the rollers 31 and 32, as shown in FIG. 1. The suction chamber 34 provides suction with a fan 35 to generate a negative pressure, and the recording paper 16 is held on the belt 33 by suction.

The belt 33 is driven in the clockwise direction in FIG. 1 by the motive force of a motor (not shown in the drawings) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33.

A heating fan 40 is disposed on the upstream side of the print unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

The print unit 12 is a so-called “full line head” in which a line head having a length corresponding to the maximum paper width is arranged in a direction (main scanning direction) that is perpendicular to the paper feed direction (see FIG. 2). Each of the print heads 12K, 12C, 12M, and 12Y is constituted by a line head, in which a plurality of ink ejection ports (nozzles) are arranged along the length that exceeds at least one side of the maximum-size recording paper 16 intended for use in the inkjet recording apparatus 10, as shown in FIG. 2.

The print heads 12K, 12C, 12M, and 12Y are arranged in the order of black (K), cyan (C), magenta (M), and yellow (Y) from the upstream side, along the conveyance direction of the recording paper 16. A color image is formed on the recording paper 16 by ejecting the inks, respectively, from the print heads 12K, 12C, 12M, and 12Y, while conveying the recording paper 16.

The print determination unit 24 comprises a line sensor for capturing images of the droplet ejection results of the print unit 12. It is possible to check for nozzle blockages, and other ejection defects, on the basis of the droplet ejection images read in by the line sensor.

An explanation is described later with reference to FIG. 1. A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

A heating and pressurizing unit 44 is provided at a stage following the post-drying unit 42. The heating and pressurizing unit 44 is a device for controlling the luster of the image surface. The image surface of the recording paper 16 is pressurized by a pressurizing roller 45 having a prescribed undulating shape on the surface thereof, while heating the recording paper 16 by means of the heating and pressurizing unit 44. Accordingly, the undulating shape on the surface of the pressurization roller 45 is transferred to the image surface of the recording paper 16.

The printed matter thus generated is cut to a prescribed size by the cutter 28, and is then output from the paper output unit 26. Desirably, the actual image that is to be printed (the printed copy of the desired image), and test prints, are output separately. In the inkjet recording apparatus 10, a sorting device (not shown) is provided for switching the outputting pathway in order to sort the printed matter with the target print and the printed matter with the test print, and to send them to paper output units 26A and 26B, respectively. If the main image and the test print are formed simultaneously in a parallel fashion, on a large piece of printing paper, then the portion corresponding to the test print is cut off by means of the cutter (mask cutter) 48.

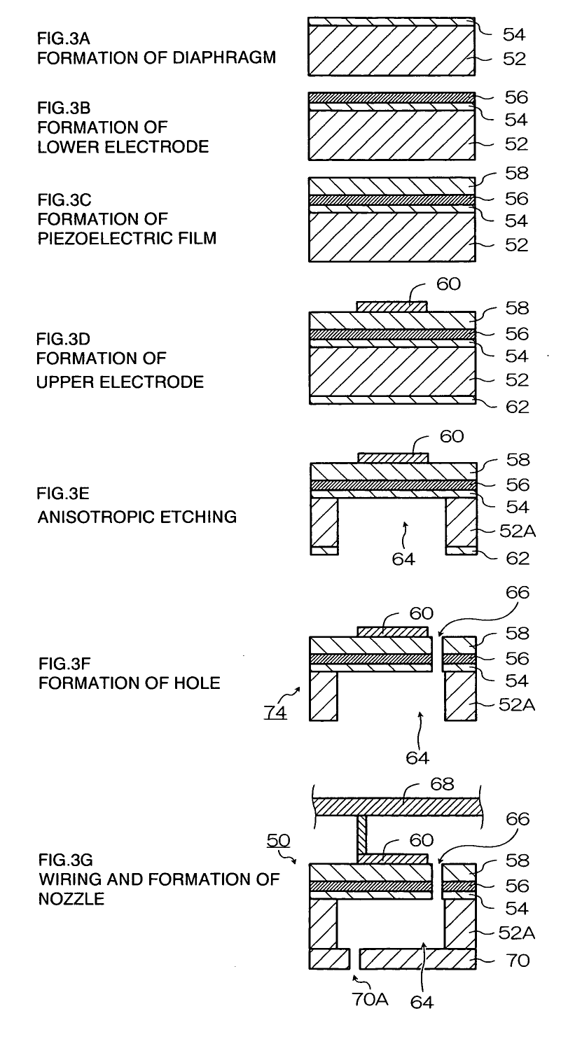

Next, a method for manufacturing the liquid ejection head according to an embodiment of the present invention is described with respect to FIGS. 3A to 3G. FIGS. 3A to 3G are cross-sectional diagrams showing steps of the manufacture of a liquid ejection head according to a first embodiment of the present invention. Although only one liquid ejection element is shown in FIGS. 3A to 3G, a plurality of liquid ejection elements are made from one substrate in actual practice.

Firstly, as shown in FIG. 3A, a substrate 52 made of directionally solidified silicon (columnar polycrystalline silicon) is prepared. The size of the substrate 52 is approximately 300 mm square and it has a thickness of approximately 0.3 mm. For example, it is possible to prepare the substrate 52 using directionally solidified silicon (columnar crystal silicon) manufactured by JEMCO INC.

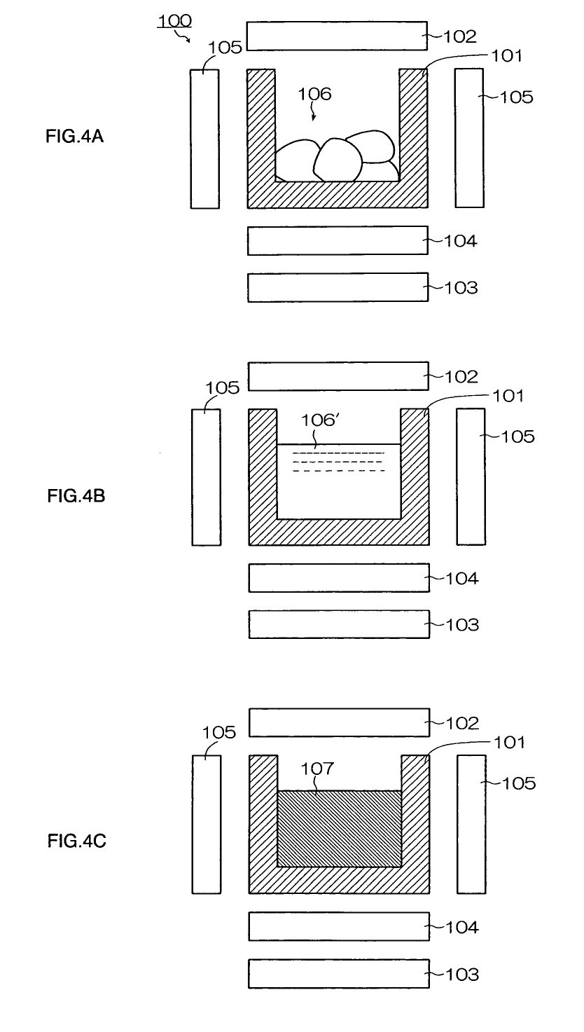

An embodiment of a process for manufacturing the substrate 52 made of directionally solidified silicon is described with reference to FIGS. 4A to 4C. FIGS. 4A to 4C are diagrams showing a method of manufacturing the substrate 52 made of directionally solidified silicon.

A silicon ingot manufacturing apparatus 100 shown in FIGS. 4A to 4C comprises: a crucible 101, which has a large horizontal cross-sectional area; a ceiling heater 102, which is disposed above the crucible 101; an underfloor heater 103, which is disposed below the crucible 101; a chill plate 104, which is disposed between the crucible 101 and the underfloor heater 103; and a heat insulating material 105, which encompasses the periphery of the crucible 101. The ceiling heater 102 and the underfloor heater 103 are heaters which heat the crucible 101 in a planar fashion and have a structure, for example, formed by processing carbon heat generating bodies in a planar shape. The silicon ingot manufacturing apparatus 100 described above is disposed inside a chamber (not illustrated) in which the internal gas can be controlled, in such a manner that oxidation of silicon material 106 during melting is prevented. For example, if a heat insulating material made of carbon fibers is used as the heat insulating material 105, then silicon carbide (SiC) may mingle with the molten silicon when melting in the crucible made of silica. Therefore, it is preferable that an apparatus for supplying inert gas to the crucible 101 is provided, thereby maintaining the interior of the crucible 101 in an inert atmosphere during the period of melting silicon.

As shown in FIG. 4A, the silicon material 106 is put into the crucible 101 so as to cover the bottom of the crucible 101, and is heated and melted by driving the ceiling heater 102 and the underfloor heater 103.

Thereupon, as shown in FIG. 4B, when the silicon material 106 melts completely into molten silicon 106′, a drive current applied to the underfloor heater 103 is halted or reduced, and a cooling medium (for example, water, or an inert gas such as argon (Ar) gas) is supplied to the chill plate 104, thereby cooling the bottom of the crucible 101. Consequently, the molten silicon 106′ is cooled from the bottom of the crucible 101, thereby generating a crystal structure of directional solidification.

Then, the temperature of the ceiling heater 102 is lowered in stages or continuously by reducing a drive current applied to the ceiling heater 102 in stages or continuously, and the directionally solidified crystal structure is thereby grown further in the upward direction. Thus, as shown in FIG. 4C, a silicon ingot 107, which has the crystal structure of directional solidification and a large horizontal cross-sectional area, is obtained. The substrates 52, which are made of directionally solidified silicon, are sliced from the silicon ingot 107 manufactured in the manner described above. The directionally solidified silicon substrate 52 manufactured as described above, has columnar crystal structure in which silicon is solidified in one direction, and the crystal grain boundaries are controlled and arranged in one direction. Furthermore, the total impurity density of the substrate 52 is approximately 10 ppm or less. In the substrate 52 manufactured as described above, the silicon crystals are aligned to have Si(001) surfaces forming the surface of the substrate 52. In other words, the directionally solidified silicon substrate 52 is a Si(001) substrate. The method of manufacturing the directionally solidified silicon substrate 52 is not limited to the method described above.

As shown in FIG. 3A, the substrate 52 is thermally oxidized by means of an electrical furnace and a silica (SiO₂) layer 54 is formed to a thickness of approximately 5 μm. It is also possible to form the silica layer, for instance, by CVD (chemical vapor deposition) method. Furthermore, material composing of silicon and other element, or silicon nitride, may be deposited instead of the silica layer 54, on the substrate 52.

Next, as shown in FIG. 3B, a lower electrode (common electrode) 56 is formed on the silica layer 54. The lower electrode 56 is formed by successively depositing, for example, a titanium (Ti) layer to a thickness of 20 nm and an iridium (Ir) layer to a thickness of 150 nm, by means of RF (radio frequency) sputter deposition method. The lower electrode 56 is subjected to a prescribed pattern formation by lithography or dry etching, for example.

Next, as shown in FIG. 3C, a film of a piezoelectric body (piezoelectric film) 58 is formed on the lower electrode 56. The piezoelectric film 58 is formed, for example, by setting the substrate temperature to 550° C. and depositing lead zirconate titanate (PZT) to a thickness of approximately 5 μm by sputtering.

Next, after annealing the piezoelectric film 58, as shown in FIG. 3D, an upper electrode (individual electrode) 60 is formed on the piezoelectric film 58. The upper electrode 60 is made, for example, of an iridium (Ir) layer having a thickness of approximately 150 nm, which is formed by liftoff method, dry etching method, or the like.

The piezoelectric film 58 and the upper electrode 60 are patterned to a size of approximately 300 μm square by RIE (Reactive Ion Etching), dry etching, sandblasting, or the like, so as to correspond to ink chambers, which are described later. Thereupon, a polyimide anti-moisture film (not shown) is formed by spin coating on the piezoelectric film 58 and the upper electrode 60.

As shown in FIG. 3D, an aluminum (Al) film 62 is formed and patterned on the lower surface of the substrate 52 in the diagram. Then, anisotropic etching is carried out by ICP-RIE (Inductive Coupled Plasma-Reactive Ion Etching) using the aluminum film 62 having prescribed pattern as a mask and the silica layer 54 as an etching stop layer. Thereby, as shown in FIG. 3E, an ink chamber 64 having an open pool structure surrounded by ink chamber partitions 52A is formed. The aluminum layer 62 is removed by etching after forming the ink chamber 64. Thus, a structure composed of the lower electrode 56, the piezoelectric film 58 and the silica layer 54 serving as a diaphragm is obtained.

In the process shown in FIG. 3E, the etching characteristics of the directionally solidified silicon substrate 52 are similar to those of a monocrystalline silicon wafer. The size of the ink chamber 64 formed in the step described with reference to in FIG. 3E is approximately 300 μm square, and the error in the size of the ink chamber 64 is ±5μm. The thickness of the ink chamber partitions 52A (the width in the lateral direction in the diagram) is between 30 μm and 70 μm, for example.

Then, as shown in FIG. 3F, an ink passage hole 66 which passes to the ink chamber 64 from the upper surface (in the diagram) of the piezoelectric film 58 having the anti-moisture film is formed by RIE. Consequently, the piezoelectric parts of the liquid ejection head are formed uniformly over the substrate 52, which is approximately 300 mm square. Thereupon, the device obtained in the step described with reference to FIG. 3F is diced to a width of approximately 30 mm and a length of approximately 230 mm.

Then, as shown in FIG. 3G, the upper electrode 60 is connected to an aluminum electrode 68, and a top plate (not shown) is bonded on the upper electrode 60. Moreover, a nozzle plate 70 having nozzle holes 70A is bonded by adhesive on the ink chamber partitions 52A, on the opposite side from the diaphragm 54.

Thus, a line-shaped liquid ejection head 50 having a jointless width of approximately 230 mm and an effective printing width of A4 size (approximately 210 mm) is manufactured. In the present embodiment, it is possible to manufacture nine (and a maximum of ten) liquid ejection heads 50 from a single substrate 52 shown in FIG. 3A, which is approximately 300 mm square.

The bending strength of the ink chamber partitions 52A of the liquid ejection head 50 is approximately 83 MPa or above, and it is possible to manufacture the liquid ejection heads having excellent rigidity, which can withstand prolonged use.

As a comparative example 1-1, a monocrystalline silicon wafer having a 6-inch diameter was used as a substrate material, then it was possible to manufacture six liquid ejection heads each having a width of 30 mm and a length of 60 mm. By connecting four liquid ejection heads together, a line-shaped liquid ejection head having an effective print width of A4size (approximately 210 mm) was obtained. As a result of a printing test carried out repeatedly scanning with the liquid ejection head in the comparative example 1-1, the bleed of the printings was more highly possible than in the embodiment of the present invention.

As a comparative example 1-2, a 300 mm-square glass substrate was used as a substrate material, then it was impossible to suitably process the glass substrate by anisotropic etching in the ink chamber formation step (see FIG. 3E), and hence poor processing accuracy was obtained. Furthermore, distortion occurred in the glass substrate due to the high temperature during the formation of the piezoelectric film, and therefore it was difficult to obtain a head of good accuracy.

In other words, according to the embodiment of the present invention, it is possible to form a long line-shaped liquid ejection head having an effective print width of an A4 size (approximately 210 mm), without joints and without creating waste. On the other hand, in the comparative example 1-1, when manufacturing a liquid ejection head of long dimensions, it was necessary to create and join together short liquid ejection heads that have a width of 30 mm and a length of 60 mm, considering the portions taken from a single wafer having a 6-inch diameter. Moreover, in the comparative example 1-1, it was difficult to join together the short liquid ejection heads with good positional accuracy, and therefore, it was difficult to improve the printing characteristics. Furthermore, in the comparative example 1-2, it was difficult to manufacture a liquid ejection head having a highly accurate shape.

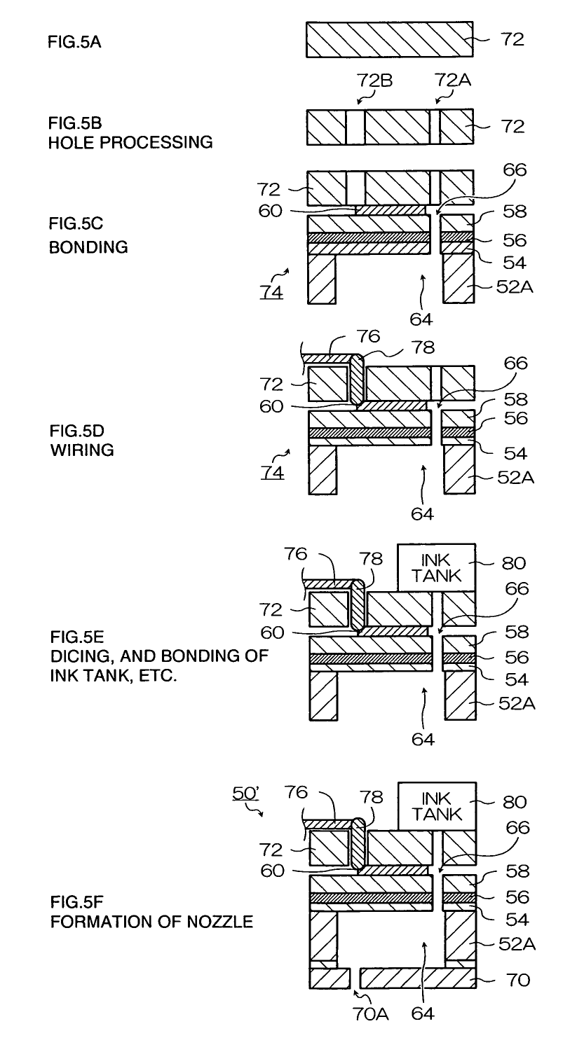

Next, a method of manufacturing a liquid ejection head according to a second embodiment of the present invention is described with reference to FIGS. 5A to 5F. FIGS. 5A to 5F are cross-sectional diagrams showing respective steps of the manufacture of a liquid ejection head. Although only one liquid ejection element is shown in FIGS. 5A to 5F, a plurality of liquid ejection elements are made from one substrate in actual practice. In the following description, parts of the composition which are similar to that shown in FIGS. 3A to 3G are denoted with the same reference numerals and description thereof is omitted.

Firstly, as shown in FIG. 5A, a directionally solidified silicon substrate of approximately 300 mm square and approximately 0.3 mm in thickness is prepared as a substrate for a top plate 72. As shown in FIG. 5B, an ink passage hole 72A and an electrode through hole 72B for wiring are formed in the top plate 72 by sandblasting.

On the other hand, the structural body 74 shown in FIG. 3F, in which the lower electrode 56, the piezoelectric film 58, the upper electrode 60 and the ink passage hole 66 are formed on the substrate 52, is obtained by means of the manufacturing steps described with reference to FIGS. 3A to 3F. As shown in FIG. 5C, the top plate 72 is bonded onto the upper electrode 60 of the structural body 74. In the step shown in FIG. 5C, the top plate 72 is arranged on the upper electrode 60 of the structural body 74 in such a manner that the positions of the ink passage hole 72A in the top plate 72 and the ink passage hole 66 in the structural body 74 are adjusted, and that the positions of the electrode through hole 72B in the top plate 72 and the upper electrode 60 in the structural body 74 are adjusted.

Next, as shown in FIG. 5D, an aluminum wire 76 is formed on the top plate 72 by sputter deposition, and is connected electrically to the upper electrode 60 by filling solder 78 into the electrode through hole 72B.

Thereupon, the device obtained in the step described with reference to FIG. 5D is diced to a width of approximately 30 mm and a length of approximately 230 mm. Then, as shown in FIG. 5E, an ink tank 80 is connected to the ink through hole 72A, and a switching IC (not shown) is connected.

Finally, as shown in FIG. 5F, the nozzle plate 70 having the nozzle holes 70A bonded by adhesive on the ink chamber partitions 52A, on the opposite side from the diaphragm 54.

Thus, a line-shaped liquid ejection head 50′ having a jointless width of approximately 230 mm and an effective printing width of A4 size (approximately 210 mm) is manufactured. In the present embodiment, it is possible to manufacture nine liquid ejection heads 50′ from the substrate 52 shown in FIG. 3A, which is approximately 300 mm square, and the top plate 72 shown in FIG. 5A.

When ink ejection is performed at 50° C. using the liquid ejection head 50′ according to the present embodiment, it is possible to eject ink satisfactorily similarly to the ejection at 20° C.

As a comparative example 2-1, a liquid ejection head was manufactured by using a directionally solidified silicon substrate having a coefficient of thermal expansion of 3.34×10⁻⁶ (1/K) as the substrate, and an epoxy substrate having a coefficient of thermal expansion of 14×10⁻⁶ (1/K)) as the top plate. When the ink ejection was performed by using the liquid ejection head in the comparative example 2-1, ink was ejected satisfactorily at 20° C.; however, at 50° C., the liquid ejection head warped due to distortion of the top plate, and hence the positional accuracy of the ejected ink declined.

According to the embodiment of the present invention, it is possible to manufacture the liquid ejection head having good thermal resistance and excellent printing characteristics, by using the directionally solidified silicon substrate as the top plate 72.

In the embodiments of the present invention described above, the directionally solidified silicon substrate is used for the substrate 52 and/or the top plate 72. Furthermore, it is also possible, for example, to use directionally solidified silicon substrates as other parts, such as the diaphragm 54 and the nozzle plate 70.

Moreover, in the embodiments of the present invention described above, the liquid ejection head 50 has the width of 230 mm and the effective print width of A4 size (approximately 210 mm). However, the present invention is not limited to this, and it is also possible to manufacture a liquid ejection head having a prescribed effective print width by altering the size of the directionally solidified silicon substrates used for the substrate 52 and the top plate 72. For example, by increasing the size of the directionally solidified silicon substrates used for the substrate 52 and the top plate 72 (for instance, approximately 880 mm square, which is an integral multiple of the length of the liquid ejection head 50), it is possible to manufacture a larger liquid ejection head.

Furthermore, the method of manufacturing a liquid ejection head according to the embodiment described above may also be applied to a case where a pressure sensor or thermal head, for example, is fabricated on a directionally solidified silicon substrate.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection head comprising a liquid ejection device which ejects liquid and is partially formed of a directionally solidified silicon substrate.

2. The liquid ejection head as defined in claim 1, wherein the liquid ejection device includes:
a nozzle plate which has nozzles arranged in an array;
pressurization liquid chambers which are bonded to the nozzle plate and respectively connected to the nozzles;
a top plate which has fluid resistance channels connecting the pressurization liquid chambers and a common liquid chamber for storing ink, the ink being supplied through the fluid resistance channels to the pressurization liquid chambers; and
a drive plate which has drive devices for causing the ink in the pressurization liquid chambers to be ejected from the nozzles,
wherein at least a part of the nozzle plate, the pressurization liquid chambers, the top plate and the drive plate is made of the directionally solidified silicon substrate.

3. The liquid ejection head as defined in claim 1, wherein the directionally solidified silicon substrate forming the liquid ejection device is constituted by a single component having a length not less than a full width of a print medium on which the ejected liquid is deposited.

4. The liquid ejection head as defined in claim 3, wherein the length of the directionally solidified silicon substrate is 150 mm or greater.

5. The liquid ejection head as defined in claim 3, wherein the length of the directionally solidified silicon substrate is 200 mm or greater.

6. The liquid ejection head as defined in claim 3, wherein the length of the directionally solidified silicon substrate is 300 mm or greater.

7. The liquid ejection head as defined in claim 1, wherein a bending strength of the liquid ejection device is not less than 83 MPa.

8. A method of manufacturing a liquid ejection head, comprising the steps of:
forming a substrate which is made of directionally solidified silicon and has a width not less than a full width of a recording medium;
forming pressurization liquid chambers and fluid resistance channels in the substrate, the fluid resistance channels connecting the pressurization liquid chambers and a common liquid chamber for storing ink, the ink being supplied through the fluid resistance channels to the pressurization liquid chambers, the ink being pressurized in the pressurization liquid chambers;
forming a drive plate which has drive devices for causing the ink in the pressurization liquid chambers to be ejected from nozzles; and
cutting out a liquid ejection head by dicing the substrate.
